(19) United States
(12) Patent Application Publication
(10) Pub. No.: US 2012/0158775 A1
(43) Pub. Date: Jun. 21, 2012

(54) SYSTEM AND METHOD FOR PROVIDING USER-CUSTOMIZED CONTENT

(75) Inventors: Geol CHOI, Daejeon (KR); Wook Ho SON, Daejeon (KR)

(73) Assignee: Electronics & Telecommunications Research Institute, Daejeon (KR)

(21) Appl. No.: 13/324,430

(22) Filed: Dec. 13, 2011

(30) Foreign Application Priority Data
Dec. 17, 2010 (KR) 10-2010-0129875

(51) Int. Cl. G06F 17/30; G06F 15/16

(52) U.S. Cl. 707/769; 709/203; 707/E17.014

(57) ABSTRACT

The system for providing user-customized content includes, a personal information database server in which user profile information and content usage history information are stored, a content server which receives user identification information and user context information from a ubiquitous sensor network, receives the user profile information and the content usage history information from the personal information database server, and searches for customized content corresponding to a user based on the received information, and a content browsing server which processes the customized content received from the content server into a form that can be displayed on a user terminal and provides the processed customized content to the user terminal. Therefore, it is possible to provide a wide range of services to the user and allow the user's personal inclination or preference as well as the user's temporal or spatial context to be subject to the services

### CROSS-REFERENCE TO RELATED PATENT APPLICATION

This application claims the benefit of Korean Patent Application No. 10-2010-0129875, filed on Dec. 17, 2010, in the Korean Intellectual Property Office, the disclosure of which is incorporated herein in its entirety by reference.

### BACKGROUND OF THE INVENTION

1. Field of the Invention

The present invention relates to a content service and, more particularly, to a system and method for providing user-customized content.

2. Description of the Related Art

In a ubiquitous environment, mobility services based on a user's location and personalized context-aware services as well as various high-speed and high-quality multimedia services are provided anytime and anywhere without limitations of time, space and object through the convergence of wired and wireless networks and the combination of ubiquitous sensors.

Under the ubiquitous environment, the available context-aware services are information providing services based on context-aware with respect to a user's temporal or spatial context. Thus, the user's personal inclination or preference has not been subject to the services. Moreover, only a few sensors mounted in a portable terminal have been used in these services, and thus there are limitations on the services that can be provided.

### SUMMARY OF THE INVENTION

The present invention has been made in an effort to solve the above-described problems associated with prior art, and an object of the present invention is to provide a system for providing user-customized content, which can broaden the scope of service and allow a user to actively use the customized content.

Another object of the present invention is to provide a method for providing user-customized content, which can broaden the scope of service and allow a user to actively use the customized content.

According to an aspect of the present invention to achieve the above object of the present invention, there is provided a system for providing user-customized content, the system comprising: a personal information database server in which user profile information and content usage history information are stored; a content server which receives user identification information and user context information from a ubiquitous sensor network, receives the user profile information and the content usage history information from the personal information database server, and searches for customized content corresponding to a user based on the received information; and a content browsing server which processes the customized content received from the content server into a form that can be displayed on a user terminal and provides the processed customized content to the user terminal.

The personal information database server may provide an interface, which allows the user to register the user profile information, and store the content usage history information.

The user context information may comprise environmental information including at least one selected from the group consisting of temperature, sound, humidity, acceleration, vibration, fire, gas, light, location, and time.

The user context information may comprise physical information including at least one selected from the group consisting of body temperature, blood pressure, pulse, electrocardiogram, and blood glucose.

The content server may comprise: a user profile analyzer which receives the user profile information from the personal information database server, analyzes the received user profile information, and provides the analyzed user profile information; a usage history analyzer which receives the content usage history information from the personal information database server, analyzes the received content usage history information, and provides analyzed content usage history information; a user context analyzer which receives the user context information from the ubiquitous sensor network, analyzes the received user context information, and provides analyzed user context information; and a customized content searcher which searches for the customized content based on at least one information selected from the group consisting of the analyzed user profile information, the analyzed content usage history information, and the analyzed user context information.

The content browsing server may provide the customized content received from the content server in the form of at least one of graph and table.

The content browsing server may provide the customized content received from the content server in the form of widget.

According to another aspect of the present invention to achieve the above object of the present invention, there is provided a method for providing user-customized content, the method comprising: obtaining, at a content server, user identification information and user context information from a ubiquitous sensor network; obtaining, at the content server, pre-stored user profile information and content usage history information from the personal information database server; searching for, at the content server, customized content corresponding to a user based on at least one information selected from the group consisting of the user profile information, the content usage history information, and the user context information; and processing, at the content browsing server, the customized content into a form that can be displayed on a user terminal and providing the processed customized content to the user terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing the configuration of a system for providing user-customized content in accordance with an exemplary embodiment of the present invention;

FIG. 2 is a block diagram showing the configuration of a content server in a system for providing user-customized content in accordance with an exemplary embodiment of the present invention; and

FIG. 3 is a flowchart of a method for providing user-customized content in accordance with another exemplary embodiment of the present invention.

### DETAILED DESCRIPTION OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

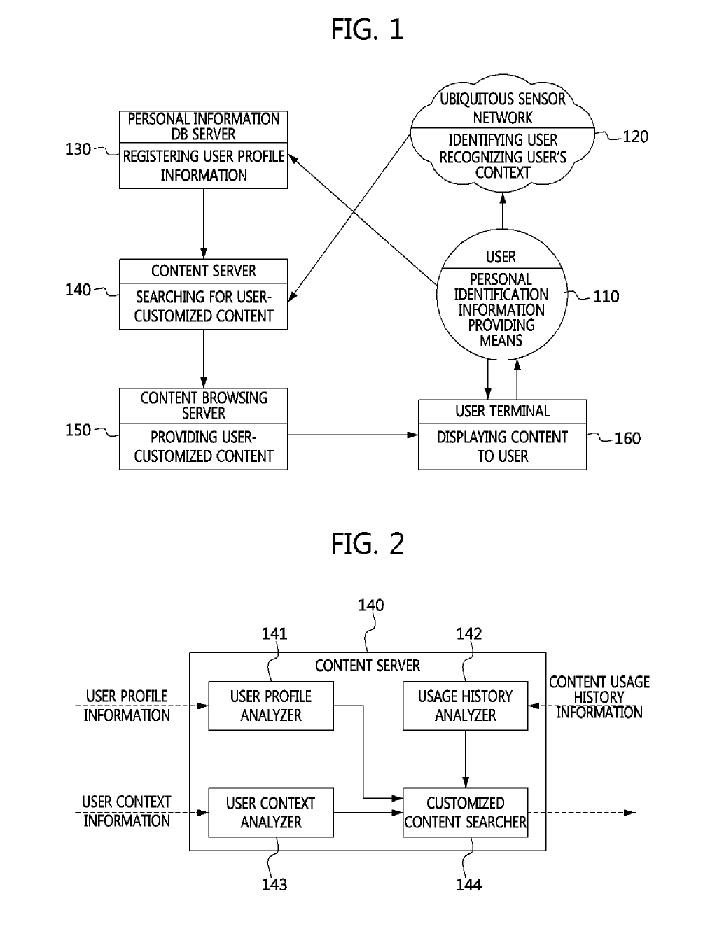

FIG. 1 is a block diagram showing the configuration of a system for providing user-customized content in accordance with an exemplary embodiment of the present invention, and FIG. 2 is a block diagram showing the configuration of a content server in a system for providing user-customized content in accordance with an exemplary embodiment of the present invention.

Referring to FIGS. 1 and 2, the system for providing user-customized content may comprise a personal identification information providing means 110, a ubiquitous sensor network 120, a personal information database server 130, a content server 140, a content browsing server 150, and a user terminal 160.

When a user enters a predetermined service area, the personal identification information providing means 110 transmits identification information that can identify the user to ubiquitous sensors located in the service area. The service area may be an area where a ubiquitous sensor network, for example, is constructed.

Here, the personal identification information providing means 110 may be a radio frequency identification tag (RFID tag), smart card, etc. in which identification information that can identify a person is stored. Moreover, the radio frequency identification tag, smart card, etc. may be included in the user terminal 160.

The ubiquitous sensor network 120 may be configured with various sensors according to a service provider's intention and obtain user context information. Here, the user context information that can be obtained from the various sensors may comprise environmental information such as temperature, sound, humidity, acceleration, vibration, fire, gas, light, location, time, domain, etc. and physical information such as body temperature, blood pressure, pulse, electrocardiogram, blood glucose, etc. The ubiquitous sensor network 120 transmits the obtained user context information to the content server 140.

Moreover, when the user enters a predetermined service area, the ubiquitous sensor network 120 obtains user identification information by sensing personal identification data from the personal identification information providing means 110 and transmits the obtained user identification information to the content server 140.

When the user subscribes to a service on a wetsite, the personal information database server 130 may provide an interface that can specify and register information regarding the user's personal inclination and preference, i.e., user profile information. Moreover, the personal information database server 130 may store content usage history information of the user.

The user profile information may include, for example, the user's age, sex, the user's favorite dress, food, music, show, etc. Moreover, the personal information database server 130 stores usual content usage history information of the user.

Further, when a user information request is received from the content server 140, the personal information database server 130 reads the user profile information and the content usage history information and transmits the read information to the content server 140.

As shown in FIG. 2, the content server 140 may comprise a user profile analyzer 141, a usage history analyzer 142, a user context analyzer 143, and a customized content searcher 144.

The user profile analyzer 141 receives the user profile information (such as the user's favorite food, music, show, etc.) from the personal information database server 130, analyzes the received user profile information, and provides analyzed user profile information.

The usage history analyzer 142 receives the content usage history information from the personal information database server 130, analyzes the received content usage history information, and provides analyzed content usage history information.

The user context analyzer 143 receives the user context information (such as the user's ambient temperature, sound, humidity, etc, and the user's body temperature, blood pressure, pulse, etc.) from the ubiquitous sensor network 120, analyzes the received user context information, and provides analyzed user context information.

The customized content searcher 144 may search for customized content based on at least one information selected from the group consisting of the analyzed user profile information, the analyzed content usage history information, and the analyzed user context information. Moreover, the customized content searcher 144 may search for customized content in conjunction with another web service.

When the customized content searcher 144 searches for the customized content suitable for the user, the content server 140 transmits the searched customized content to the content browsing server 150.

Moreover, the content server 150 analyzes the user context information received from the ubiquitous sensor network 120 and the user profile information and content usage history information received from the personal information database server 130. Here, the content server 140 may search for content that may be of interest to the user in conjunction with another web service.

The content server 140 may comprise a mass storage device in which a plurality of content data, content-related additional information, etc. are stored.

The content browsing server 150 processes the customized content received from the content server 140 into a form that can be displayed on the user terminal 160 and provides the processed customized content to the user terminal 160.

In this case, the content browsing server 150 may provide the customized content received from the content server 140 in the form of at least one of graph and table. For example, the content browsing server 150 may provide the customized content received from the content server 140 in the form of widget.

The user terminal 160 is a terminal that the user can carry and displays the user-customized content received from the content browsing server 150 in real time.

The user terminal 160 may include, for example, personal digital assistants (PDAs), enterprise digital assistants (EDAs), cellular phones, pagers, digital cameras, digital camcorders, portable media players, e-book readers, personal navigation devices, etc.

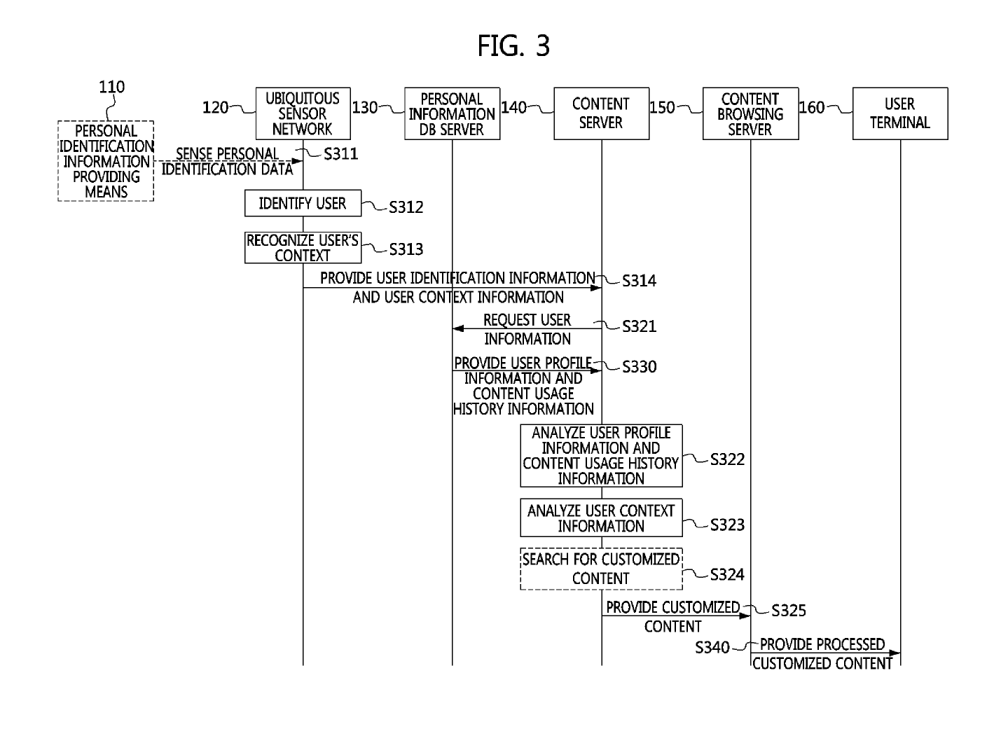

FIG. 3 is a flowchart of a method for providing user-customized content in accordance with another exemplary embodiment of the present invention.

In the flowchart of the method for providing user-customized content shown in FIG. 3, it is assumed that a user has subscribed to a service on a website and user profile information has been specified and registered.

As shown in FIG. 3, when the user wearing or carrying a personal identification information providing means 110 such as a radio frequency identification tag, smart card, etc. enters a predetermined service area, a ubiquitous sensor network 120 senses personal identification data (S311) and obtains user identification information (S312).

Moreover, the ubiquitous sensor network 120 obtains user context information including environmental information such as temperature, sound, humidity, acceleration, vibration, fire, gas, light, location, time, domain, etc. and physical information such as body temperature, blood pressure, pulse, electrocardiogram, blood glucose, etc. from various sensors configured according to a service provider's intention (S313) and provides the obtained information to a content server 140 (S314).

The content server 140 which has obtained the user identification information and the user context information requests user profile information and content usage history information from a personal information database server 130 (S321).

The personal information database server 130 transmits the user profile information and the content usage history information of the corresponding user requested by the content server 140 to the content server 140 (S330).

The personal information database server 130 stores the user profile information and the content usage history information of the corresponding user regarding the user's pre-stored personal inclination and preference and periodically manages the user profile information and the content usage history information of the user.

Here, the user profile information may include, for example, the user's age, sex, the user's favorite dress, food, music, show, etc.

Moreover, the content usage history may be stored in association with, for example, the name of content, the date and time of content use, the number of times of content use, or the content-related additional information (such as content category, content producer, content production company, content execution time, content fee, etc.) for each content used by the user.

The content server 140 analyzes the user profile information and the content usage history information of the user received from the personal information database server 130 (S322). Moreover, the content server 140 analyzes the user context information received from the ubiquitous sensor network 120 (S323).

In this case, the content server 140 may search for customized content based on the analyzed data. Moreover, the content server 140 may search for customized content that may be of interest to the user or that may be required depending on the context of the user (S324). Further, the content server 140 transmits the searched content suitable for the user to the content browsing server 150 (S325).

The content browsing server 150 processes the customized content received from the content server 140 into a form that can be displayed on the user terminal 160 and provides the processed customized content to the user terminal 160 (S340). Moreover, the content browsing server 150 may provide the customized content received from the content server 140 in the form of at least one of graph and table.

The user terminal 160 displays the user-customized content in the form of graph and/or table in an easily accessible manner in real time. Therefore, the user can be provided with the customized content through the user terminal 160 in real time.

As described above, the system for providing user-customized content in accordance with an exemplary embodiment of the present invention comprises a personal information database server in which user profile information and content usage history information are stored, a content server which receives user identification information and user context information from a ubiquitous sensor network, receives the user profile information and the content usage history information from the personal information database server, and searches for customized content corresponding to a user based on the received information, and a content browsing server which processes the customized content received from the content server into a form that can be displayed on a user terminal and provides the processed customized content to the user terminal.

Therefore, it is possible to provide the system and method for providing user-customized content, which can broaden the scope of service to be provided, provide a wide range of context-aware-based services, allow the user's personal inclination or preference to be subject to the services, and allow the user to actively use the customized content.

Moreover, the system and method for providing user-customized content according to the present invention can be widely utilized in various ubiquitous computing services, ambient intelligence-based services, etc. as well as personalized advertisements and u-health care services.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A system for providing user-customized content, the system comprising:
a personal information database server in which user profile information and content usage history information are stored;
a content server which receives user identification information and user context information from a ubiquitous sensor network, receives the user profile information and the content usage history information from the personal information database server, and searches for customized content corresponding to a user based on the received information; and
a content browsing server which processes the customized content received from the content server into a form that can be displayed on a user terminal and provides the processed customized content to the user terminal.

2. The system of claim 1, wherein the personal information database server provides an interface, which allows the user to register the user profile information, and stores the content usage history information.

3. The system of claim 1, wherein the user context information comprises environmental information including at least one selected from the group consisting of temperature, sound, humidity, acceleration, vibration, fire, gas, light, location, and time.

4. The system of claim 1, wherein the user context information comprises physical information including at least one selected from the group consisting of body temperature, blood pressure, pulse, electrocardiogram, and blood glucose.

5. The system of claim 1, wherein the content server comprises:
a user profile analyzer which receives the user profile information from the personal information database server, analyzes the received user profile information, and provides the analyzed user profile information;
a usage history analyzer which receives the content usage history information from the personal information database server, analyzes the received content usage history information, and provides analyzed content usage history information;
a user context analyzer which receives the user context information from the ubiquitous sensor network, analyzes the received user context information, and provides analyzed user context information; and
a customized content searcher which searches for the customized content based on at least one information selected from the group consisting of the analyzed user profile information, the analyzed content usage history information, and the analyzed user context information.

6. The system of claim 1, wherein the content browsing server provides the customized content received from the content server in the form of at least one of graph and table.

7. The system of claim 1, wherein the content browsing server provides the customized content received from the content server in the form of widget.

8. A method for providing user-customized content, the method comprising:
obtaining, at a content server, user identification information and user context information from a ubiquitous sensor network;
obtaining, at the content server, pre-stored user profile information and content usage history information from the personal information database server;
searching for, at the content server, customized content corresponding to a user based on at least one information selected from the group consisting of the user profile information, the content usage history information, and the user context information; and
processing, at the content browsing server, the customized content into a form that can be displayed on a user terminal and providing the processed customized content to the user terminal.

9. The method of claim 8, wherein the obtaining the user profile information and the content usage history information comprises providing, at the personal information database server, an interface which allows the user to register the user profile information.

10. The method of claim 8, wherein the user context information comprises environmental information including at least one selected from the group consisting of temperature, sound, humidity, acceleration, vibration, fire, gas, light, location, and time.

11. The method of claim 8, wherein the user context information comprises physical information including at least one selected from the group consisting of body temperature, blood pressure, pulse, electrocardiogram, and blood glucose.

12. The method of claim 8, wherein the providing the processed customized content to the user terminal comprises:
generating the customized content by processing the customized content in the form of at least one of graph and table; and
providing the generated customized content to the user terminal.

13. The method of claim 8, wherein the providing the processed customized content to the user terminal comprises:
generating the customized content in the form of widget; and
providing the customized content generated in the form of widget to the user terminal.
